(19) United States
(12) Patent Application Publication
(10) Pub. No.: US 2018/0140381 A1
(43) Pub. Date: May 24, 2018

(54) GUIDED ORTHODONTIC BRACKET APPLICATION

(71) Applicant: UNIVERSITY OF FLORIDA RESEARCH FOUNDATION, INC., GAINESVILLE, FL (US)

(72) Inventors: NIKOLAUS GRAVENSTEIN, GAINESVILLE, FL (US); CALOGERO DOLCE, GAINESVILLE, FL (US); SAMSUN LAMPOTANG, GAINESVILLE, FL (US); DAVID ERIK LIZDAS, GAINESVILLE, FL (US)

(21) Appl. No.: 15/579,426

(22) PCT Filed: Jun. 27, 2016
(86) PCT No.: PCT/US2016/039516

§ 371 Date: Dec. 4, 2017

Related U.S. Application Data
(60) Provisional application No. 62/185,376, filed on Jun. 26, 2015.

(51) Int. Cl. A61C 7/00; A61C 7/14

(52) U.S. Cl. CPC A61C 7/002; A61C 7/28; A61C 7/146

(57) ABSTRACT

A computer-implemented method and system for guiding the placement of orthodontic brackets are provided. The system can include an at least one indexing tool designed to conform to at least a portion of a patient's teeth or alveolar process. The system can receive signals from a sensor at the indexing tool as well as signals from a sensor at a bracket positioning tool in order to track spatial location—and/or orientation of one or more brackets relative to the surface of the patient's actual or modeled teeth. A method for guiding the placement of orthodontic brackets involves detecting the location and/or orientation of a bracket with respect to at least one tooth of a patient and notifying the orthodontist that the actual bracket position and/or orientation meets specified criteria with respect to planned placement coordinates for the bracket. The method can further include collecting the planned placement coordinates for each bracket tooth combo during a planning phase.

### CROSS-REFERENCE TO A RELATED APPLICATION

This application claims the benefit of U.S. provisional application Ser. No. 62/185,376, filed Jun. 26, 2016, which is incorporated herein by reference in its entirety.

### BACKGROUND

For an orthodontic treatment, a dentist manually attaches brackets, which can be made from stainless steel or ceramic materials, to a patient's teeth using a composite resin (dental cement). Afterwards, metal wires are inserted into the orthodontic brackets (braces). These wires interact with the brackets to shift each tooth into a predetermined position to correct a misaligned bite or to straighten a crooked tooth. In particular, braces are often used to correct various malocclusions including under-bites, overbites, cross bites, open bites, deep bites, crooked teeth, and various other flaws of the teeth and jaw. The coupling of the wires to the brackets not only helps to position the teeth with regard to a person's bite, but also helps to improve self-esteem.

This orthodontic process, of applying brackets to teeth, can be labor intensive and operator dependent. Consequently, this process may not be reliably accurate and may be error prone. Typically, a patient will require approximately 28 brackets on the incisors (8), canines (4), premolars (8) and molars (8). Each bracket must be properly positioned relative to the tooth and other adjacent brackets to ensure proper alignment of the wires coupled thereto. As such, there is considerable room for error in the placement and positioning of the brackets.

### BRIEF SUMMARY

Aspects of this disclosure describe a system and computer-implemented method for guiding the placement of orthodontic brackets. Advantageously, through using the described techniques, the orthodontic process may be less labor intensive and error prone and require the patient to spend less time at the dentist's office. It may also be more comfortable for patients if the time to place brackets is shortened because they may not have to suffer the discomfort of keeping their mouth wide open for long stretches of time.

“Position” in this patent narrative, claims and figures is understood to mean at least one of the coordinates of location (x, y, z) and orientation (yaw, pitch, roll).

A method for guiding the placement of orthodontic brackets involves detecting the position and/or orientation of at least one actual orthodontic bracket in proximity to at least one tooth of a patient and notifying the orthodontist that the actual orthodontic bracket position and orientation meets specified criteria with respect to planned placement coordinates, e.g., 6 Degrees of Freedom (DOF) for the bracket. The method can further include collecting the planned placement coordinates (e.g. 6 DOF coordinates) for the bracket during a planning phase in which a bracket positioning tool is tracked with respect to a physical model of the patient's teeth collocated with a virtual model of the patient's teeth. The method may further indicate a planned position for a bracket with respect to at least one tooth, including appropriate position and orientation information stored as the planned placement coordinates.

An orthodontic bracket application system can include an indexing tool designed to uniquely conform to at least a portion of a patient's teeth or alveolar process. The indexing tool is configured so that it can exchangeably fit to both a patient's actual mouth and a physical model or replica (such as a 3D-printed replica of the teeth and gums based on a medical scan of the mouth) of the patient's mouth. The indexing tool may include one or more sensors (such as tracking sensors) for detecting the position and orientation of a patient's actual or modeled teeth; the sensor may track multiple DOF such as, for example, 3, 4, 5 or preferably 6 DOF: x, y, z, yaw, pitch and roll. The system further includes a bracket positioning device that enables an orthodontist or an assistant to plan bracket positioning with respect to the patient's modeled teeth. If a lower-paid qualified assistant can do the planning, then a supervising orthodontist can verify/approve the assistant's work, lowering cost and increasing throughput. The same bracket positioning device as used to plan the bracket position or a different bracket positioning device may be used for actual bracket placement. A bracket positioning device includes one or more sensors (such as 6 DOF tracking sensors) for detecting the position and orientation of a bracket being positioned by the device; the tracking sensor may be a 3, 4, 5 or preferably 6 DOF: x, y, z, yaw, pitch and roll.

A guided bracket application program and graphical user interface can be provided in which a virtual model of the patient's teeth can be displayed. Further, the position and/or orientation of a bracket with respect to a patient's actual or modeled tooth can be displayed as a virtual representation of the bracket and tooth on the user interface. A tracking module of the guided bracket application program can receive the tracking sensor data from the indexing tool and the bracket positioning device. Further, the tracking module can track the spatial position and/or orientation of one or more physical or virtual brackets relative to the surface of the patient's actual or modeled (physical model and virtual model) teeth.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example of an operating environment for guided orthodontic bracket application as described herein.

FIGS. 2A and 2B illustrate processes for guided orthodontic bracket application.

FIG. 3 shows an example implementation of a process for guided orthodontic bracket application that may be carried out by a system as described herein.

FIG. 4 illustrates an example bracket positioning device.

FIGS. 5A and 5B illustrate a perspective view and bottom view, respectively, of an orthodontic bracket.

FIG. 6 illustrates a first tip used for bracket placement having an orthodontic bracket removably coupled thereto.

FIG. 7 shows a bracket positioning device with a bracket planning pointer tip removably coupled thereto and various exchangeable bracket and/or tip for coupling thereto.

FIG. 8 shows an upper dental arch 800 of the patient's actual teeth 150 or a physical model of the patient's teeth 151.

FIG. 9 shows an indexing tool 120 fitted to the dental arch 800 of FIG. 8.

FIG. 10 shows an example conformal side of the indexing tool 120 that is unique to a given patient.

FIG. 11 illustrates placement of a bracket 500 according to an example implementation.

FIG. 12 shows a graphical user interface 1200 with a representation of a virtual model 1210 of a person's upper arch 800 on which a representation of a bracket may be displayed during a planning stage.

FIG. 13 shows a graphical user interface 1300 with a representation of a virtual model 1210 of a person's upper arch 800 on which a representation of a planned bracket position 1315 and a representation of a detected bracket position 1320 is displayed during a placement stage.

FIG. 14 shows a block diagram of a computing system 1400 for a computer device that may be used to implement certain techniques described herein.

### DETAILED DESCRIPTION

Systems and methods for guiding the placement of orthodontic brackets are described. A computing system executing a guided orthodontic bracket software application can provide audio and/or visual/graphical assistance for an orthodontist's application of brackets to a patient's teeth.

The described system, devices, and techniques can be used during a planning stage where an operator applies brackets onto a physical replica or model of a person's teeth that can be readily held by hand, manipulated, oriented and angled for best view and/or placement. During this planning stage, the computing system receives first tracking data from an indexing tool fitted to the physical replica or model of the person's teeth and second tracking data from a bracket positioning device. The indexing tool includes one or more sensors and is configured to interchangeably abut at least a portion of the patient's actual teeth (and/or alveolar process) and the model of the patient's teeth (and/or alveolar process). Importantly, the patient does not need to be present during the planning stage.

Different types and sizes of brackets are used for a given set of teeth. Molars may require different types of brackets from incisors. The operator uses the bracket positioning device to position brackets on the model of the teeth, while one or more sensors of the bracket positioning device are used to detect the position of the representative (selected) bracket held by the bracket positioning device, such that a computing system can spatially register the position of the representative (indicated and/or selected) bracket with respect to the surface of each associated tooth. Once the operator indicates a desired final position of a bracket on the physical model, the position can be saved, for example, as a corresponding virtual bracket position (set of coordinates) on a digitized virtual model of the person's teeth stored within the computing system. This final position, which is stored as a virtual bracket position, may then be used to facilitate the proper placement of a bracket on the person's corresponding tooth.

The described system, devices, and techniques can also be used during a placement stage, where the operator applies brackets to the patient's actual teeth. In particular, during the placement stage, the same or a similar indexing tool as the one used in the planning stage with one or more sensors is placed within the patient's mouth. The same bracket positioning tool used during the planning stage can be used to bond brackets onto the person's actual teeth or another bracket positioning tool having the one or more sensors can be used. As the operator positions or adjusts a bracket into place for each tooth, the one or more sensors from the indexing tool and the bracket positioning tool transmit data to the computing system to detect the real-time position of each tooth and the bracket. The actual bracket's position is compared by the system to the stored bracket position—collected during the planning stage—for each corresponding tooth. The operator is notified by visual, audio, and/or tactile or other cues when the actual bracket's position meets a specified criteria with respect to the stored bracket position. For example, when the actual bracket and stored bracket positions match within acceptable ranges, the computer system may indicate that the actual position is at or near the stored bracket position.

The computing system can display a graphical user interface for the guided orthodontic bracket software application. A virtual model of the patient's teeth can be displayed on the graphical user interface. Further, the position of a bracket with respect to a patient's actual or modeled tooth, as detected by the indexing tool, can be shown as a virtual representation of the bracket within the user interface.

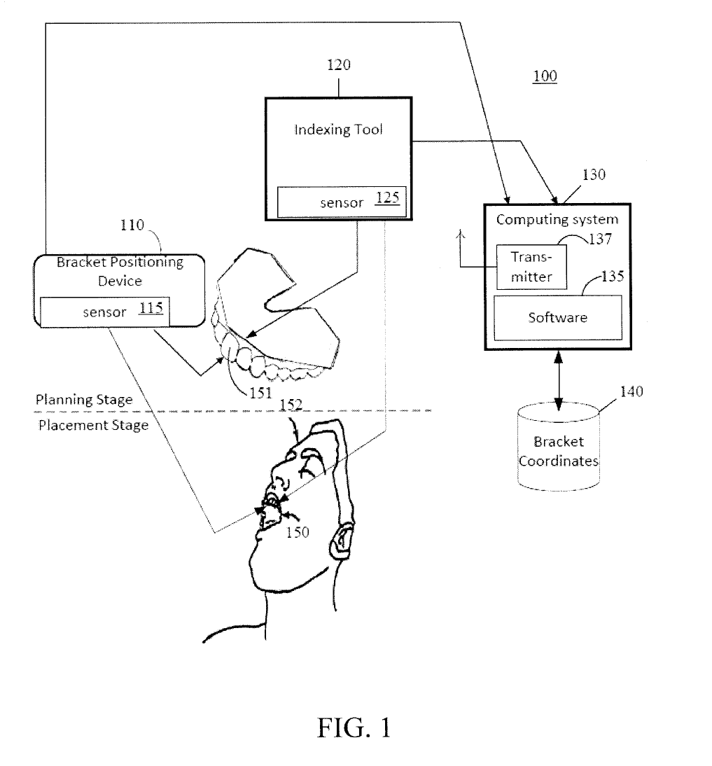

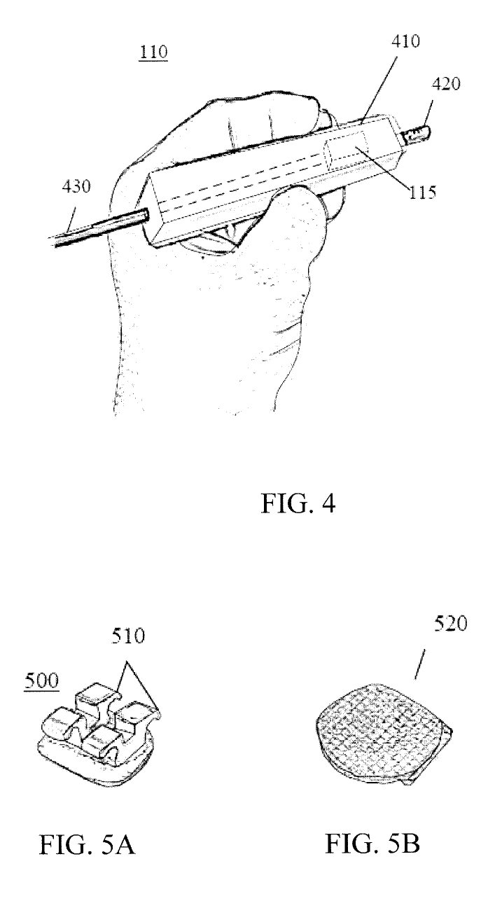

FIG. 1 illustrates an example of an operating environment for guided orthodontic bracket application. An orthodontic bracket application system 100 can include a bracket positioning device 110 with one or more tracking sensors 115, an indexing tool 120 with one or more tracking sensors 125, a computing system 130, and storage system 140. The bracket positioning device 110 is used for applying a bracket. The bracket positioning device 110 can be any size or shape sufficient to enable ease of use for application of brackets to a physical or virtual model or actual teeth. Such bracket positioning device 110 can be oblong, circular, rectangular, or possess an ergonomic shape or design. The bracket positioning device 110 may be used as an actual bracket applicator to apply a bracket during a placement stage. In the alternative, the bracket positioning device 110 may be used to apply a dummy (or representative) bracket applicator during a planning stage. Accordingly, the same positioning device 110 may be used for both the planning stage and the placement stage, wherein the bracket positioning device 110 possesses a universal bracket holder or an interchangeable bracket holder. An example bracket positioning device is illustrated in FIG. 4. The bracket holder holds the bracket such that the bracket cannot move respective to the tracking sensors in the bracket positioning device. The positioning device includes a release mechanism that releases the actual bracket from the positioning tool when the actual bracket position matches the stored position. The bracket release can be controlled manually by the user and/or by the software when the actual and stored positions match within limits.

The bracket positioning device 110 with tracking sensor(s) 115 and the indexing tool 120 with tracking sensor(s) 125 may provide positional and/or orientational data (or at least sensor signals) to the computing system 130, such that a bracket position deemed optimal or adequate can be spatially registered with the respective person's tooth 150 and the physical model of the person's tooth 151. The sensors 115 may be molded within the bracket positioning device 110 or sit within a hollow portion of the bracket positioning device 110. Output from the sensors 115 may be communicated to the computing system 130 through, for example, an output cable extending from bracket positioning device 110 to the computing system 130 or wirelessly e.g. via Bluetooth™. The types of sensors 115 useful in the bracket positioning device 110 may include, but are not limited to, electric current, electric potential, magnetic, radio, proximity, and laser sensors. The types of sensors 125 useful in the indexing tool 120 may include, but are not limited to, electric current, electric potential, magnetic, radio, proximity, and laser sensors. In some cases, an optical tracking system can be used in addition to or as an alternative to certain of the sensors of the bracket positioning device and/or indexing tool. In a specific implementation, magnetic sensors are used for the sensors 115 and 125. These magnetic sensors may communicate wirelessly with a transmitter 137 such as one manufactured by NDI/Ascension Technology Corporation located within computer system 130. Although the transmitter 137 is illustrated to be located within computing system 130, transmitter 137 may be externally coupled to the computing system 130. A communication channel between the magnetic sensors may be a wired or wireless network, or any variety of other communication links. This communication channel may carry signals and can be implemented using a variety of wired or wireless communication means including wire or cable, fiber optics, conventional phone line, cellular phone link, wireless data communication link, RF link (such as Bluetooth™), or infrared link, just to name a few.

The indexing tool 120 can conformingly abut at least a portion of a patient's 152 actual or model teeth or alveolar process 150. Signals from the indexing tool 120 and the bracket positioning device 110 can be transmitted through a communications system or any other type of network to the computing system 130. The communications system may include antennas, power amplifiers, RF circuitry, transceivers, and other communication circuitry. Communication of signals by the communications system may be WiFi, cellular, radio/microwave frequency, Ultra High Frequency (UHF), or other far or near-field communication modality (or combination thereof) depending on implementation. In some cases, communication may be over wired (e.g., USB, HDMI) communication media. The body of the indexing tool (e.g., indexing tool 120) is molded (or cast or printed or other fabrication technique) so that it fits conformal with at least a portion of the teeth and/or alveolar process of the physical model 151.

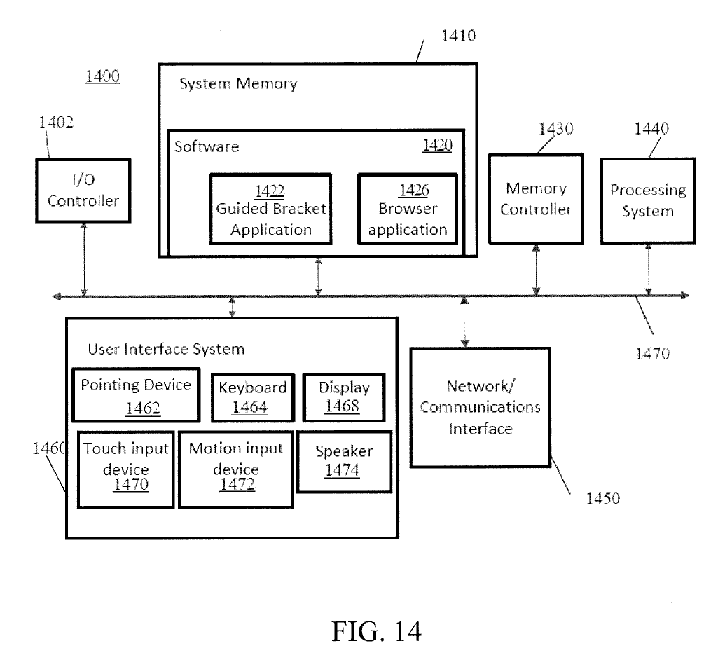

The computing system 130 can be a computing device (such as system 1400 described in more detail with respect to FIG. 14). The computing system 130 can store and execute a guided orthodontic bracket software application 135. The storage system 140 may be separate from or part of the computing system 130, and may store coordinates or other information indicating final bracket positions selected during the planning stage. In addition to storing coordinates (or other information) for final bracket positions, the storage system 140 can store a virtual model of the patient's teeth and the type of bracket selected for each tooth as well as the position of each bracket. The virtual model may be generated by a digital data set representing the person's teeth arrangement. This digital data set may be obtained in a variety of ways. For example, the person's teeth may be scanned or imaged using technology, such as optical image processing, optical 3D image reconstruction, X-rays, three-dimensional X-rays, computer-aided tomographic images or data sets, and magnetic resonance images.

The storage system 140 may be any suitable storage media including removable and non-removable, volatile and non-volatile memory as well as the “cloud.”

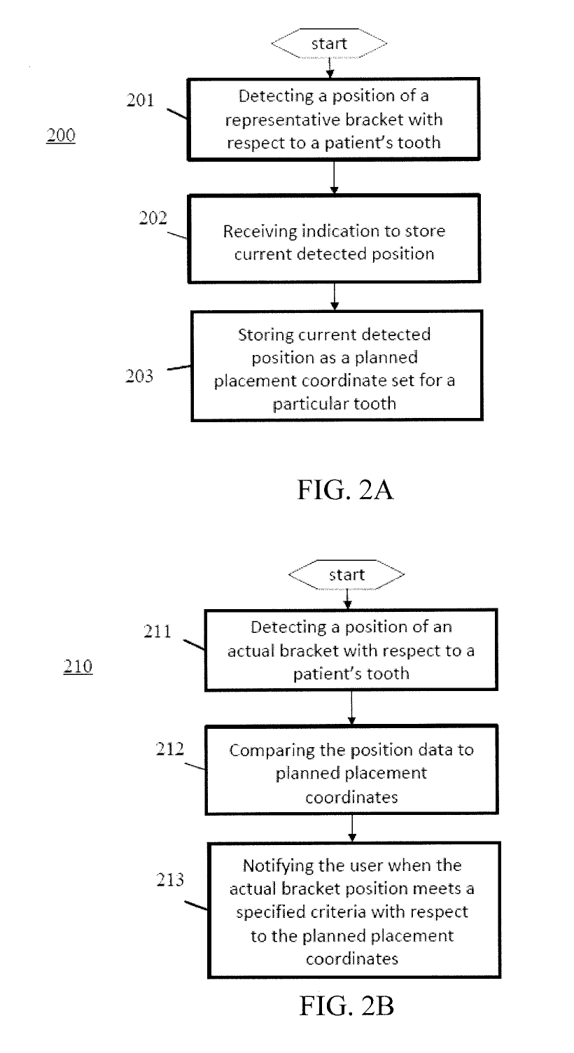

FIGS. 2A and 2B illustrate processes for guided orthodontic bracket application. The processes 200 and 210 may be implemented by the guided orthodontic bracket software application 135 and executed by computing system 130 of FIG. 1. Referring to FIG. 2A, for a planning mode, the process 200 can begin with detecting a position of a representative bracket with respect to a patient's tooth (201).

During this stage, the orthodontist can plan the positioning and type of bracket used on each tooth of the patient by interacting with a physical model of the patient's teeth, which may have been created from the same images/data obtained for the virtual model of the patient's teeth (e.g., generated through x-ray, optical scanning, or other scanning modalities).

In the alternative, the position of a bracket with respect to a patient's tooth can be sensed using the indexing tool 120 as the orthodontist moves the bracket positioning device around the physical model 151 of the patient's teeth. Signals from the indexing tool 120 and the bracket positioning device 110 are received by the computing system 130 and interpreted to detect relative position between a representative bracket and a tooth during step 201. The “bracket” used by the bracket positioning device 110 during planning may be an actual bracket, a model of a bracket, a tip of the positioning device or other suitable representation. In some cases, the guided orthodontic bracket software application 135 can include a feature by which the orthodontist can select the particular bracket (and/or bracket size and shape) that the representative (virtual) bracket is to actually represent. Other features available to the orthodontist include, but are not limited to, selection of tooth, navigation and interaction with a visual representation of the virtual model of the patient's teeth (and even interaction with—or at least viewing of—a visual representation of the virtual bracket(s)).

For each tooth on which a bracket is to be placed, the orthodontist can provide an indication that they have decided upon a desired location for the bracket. The indication can be made using an interface to the system 130. The interface to the system can include input devices such as a keyboard, touch screen, mouse, foot pedal input device, foot switch, or microphone as some examples. The indication by the orthodontist represents an indication to store a current detected position. When the system 130 receives the indication to store a current detected position (202), the process directs the system to store the current detected position as a planned placement coordinates for a particular tooth (203). The planned placement coordinates can be saved in a file (or other structure) in a storage media associated with the computing system (e.g., storage media 140).

Referring to FIG. 2B, during the placement stage, which may take place on a same or different date than the planning stage for a particular patient, the same or identical, clean indexing tool 120 used during the planning stage can be inserted into the patient's mouth. A bracket positioning device 110 can be used to apply the brackets. The process 210 can begin, for example, by the system 100 detecting a position of an actual bracket with respect to a patient's tooth (211). The planned placement coordinates may be loaded into the system or accessed by the system and the position data detected by the indexing tool 120 can be compared to the planned placement coordinates (212). The comparison may be done by comparing any suitable form of the data (e.g., raw signal data, registration data, coordinates and the like). In some cases, the comparison may be carried out by the software. In other cases, a hardware comparator may be used. In some cases, the system 130 may display the detected bracket position on a virtual model of the patient's teeth and display visual cues, instruction text or graphical cues as to the relationship between the detected bracket position and the stored planned bracket position. The indexing tool may consist of more than one part, one for the upper jaw and one for the lower jaw.

When the system 130 determines that the actual bracket position meets a specified criteria with respect to the planned placement coordinates, the user is notified (213). Examples of specified criteria for the comparison include when the detected bracket position has coordinates the same as or is within a particular tolerance offset of the proposed set of coordinates. Notification to the user may be visual, audible, and/or tactile. For implementations in which a virtual model of the patient's teeth is displayed, a visual indication can be provided showing the detected bracket position aligning with the planned bracket position by changing the color of the virtual bracket in the display.

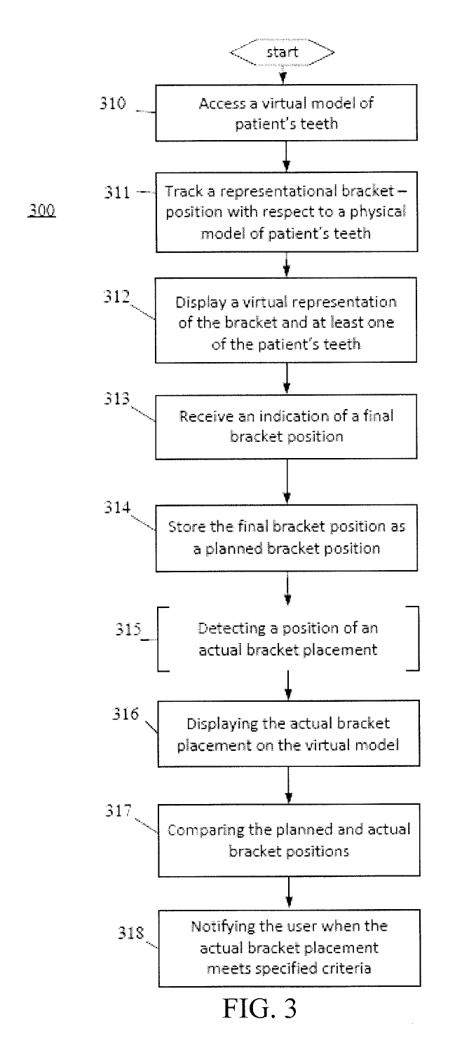

FIG. 3 shows an example implementation of a process for guided orthodontic bracket application that may be carried out by a system as described herein. In particular, a method of guided orthodontic bracket application 300 may include a planning stage and a placement stage. The particular stage, or mode, can be entered into by a selection or other command using a user interface of the system. In some cases, the planning stage may automatically initiate when new patient information is entered.

During the planning stage, the system may access a virtual model of the patient's teeth (310). The virtual model of the patient's teeth can be generated from a digital data set obtained in one or more of a variety of ways. For example, the person's teeth may be scanned or imaged using technology, such as X-rays, three-dimensional X-rays, computer-aided tomographic images or data sets, and magnetic resonance images, or optical scans. For example, the virtual model may be generated from images taken by an optical scanner that outputs a 3D object in .stl format that is compatible with 3D printers. Once generated, the virtual model can be stored, for example, on storage media 140 such as shown in FIG. 1 and accessed (310) by the system for guided orthodontic bracket application. The resulting virtual 3D model can be 3D printed to make the physical model 151.

Using an indexing tool 120 positioned with respect to a physical model 151 of the patient's teeth (which may also be generated using the digital data set), the system 100 may then track a representational bracket and its position, using a bracket positioning device 110, with respect to the physical model of the patient's teeth (311). This positional data can be registered to the virtual model so that the system can display the movement and location of a virtual bracket with respect to the virtual model of the patient's teeth (312). At least one of the patient's teeth may be shown as part of the display. The operator can select the final position of a bracket and indicate this selection (e.g., using a user input device). When the system receives the indication of final bracket position (313), this position can be saved as a planned bracket position or coordinates in memory (or other associated storage media) (314) for that particular tooth. This final position can be accessed when the operator later bonds the brackets to the patient's teeth. The process can be repeated for all teeth.

Advantageously, the amount of time that a patient sits in the orthodontic chair can be reduced as the planning stage can be carried out without the patient on the premises and may be done at the convenience of the orthodontist or an assistant. In addition, numerous options and strategies may be determined and stored during the planning stage. Then, during the placement stage, the system may detect and track an actual bracket in proximity to the patient's tooth/teeth (315). The system may also display this tracked position along with the virtual model (316). Further, the system compares the bracket's tracked position to the position data of the final planned bracket position (317). When the tracked bracket position matches the position data of the final planned bracket or otherwise meets specified criteria, the system notifies the operator (318). This indication of the matching bracket positions can be provided, for example through a graphical user interface or as an alert or notification (using a speaker, text, tactile feedback, color change and/or flashing on a display or some other output interface.).

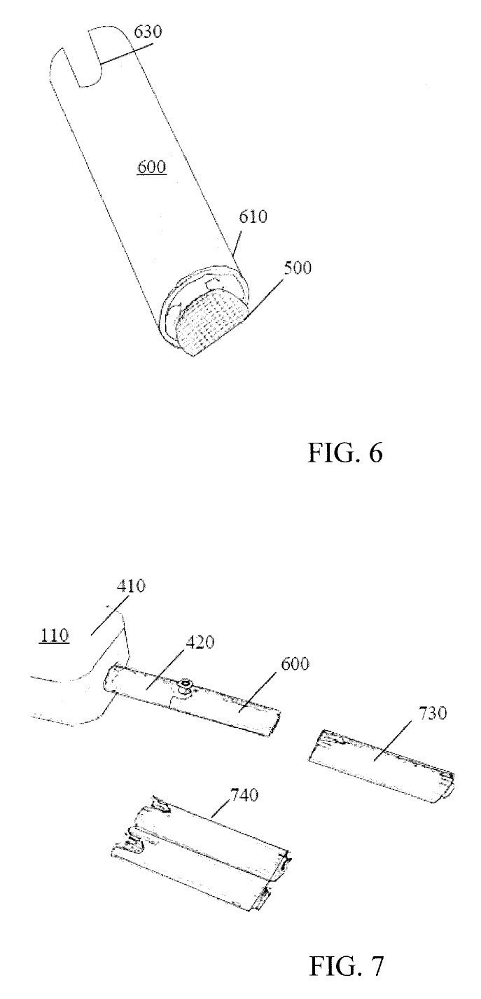

FIG. 4 illustrates an example bracket positioning device 110. The illustrated bracket positioning device 110 can be used to position a bracket and/or a representative bracket on a patient's tooth (or physical model of the patient's tooth). The bracket positioning device 110 can be any size or shape sufficient to enable ease of use for application of brackets to actual teeth or a model thereof. Such bracket positioning device 110 can be circular or rectangular in cross section. The particular example shown in FIG. 4 possesses a rectangular cross-section, having six sides; wherein two sides are notably smaller than the four lengthy rectangular sides. The bracket positioning device 110 may possess an ergonomic shape or design to enable ease of use. The bracket positioning device 110 may be solid, hollow, porous, or have other properties as desired. The bracket positioning device 110 may include a handle 410 containing a bracket positioning sensor and having a socket with an indexing pin 420 for coupling to either a bracket planning pointer tip or a bracket placement tip (as described in FIGS. 6 and 7). The bracket positioning sensor (see e.g., tracking sensor 115 of FIG. 1) is provided for sensing the spatial position of the bracket positioning device, and thereby the position of a bracket at a tip of the bracket positioning device. The sensor may be embedded within or disposed exteriorly of the handle 410. The sensors 115 may be molded within the handle 410 or tip 420. In the alternative, sensors 115 may sit within a hollow portion of the handle 410 or tip 420. Output from the sensors 115 may be communicated to the computing system 130 through cable 430 extending from bracket positioning device 110 to the computing system 130. The socket (and indexing pin 420) may include circuitry that can be used to indicate what type of bracket is attached. The bracket positioning device 110 may possess a grip element having an ergonomically optimal design to further enable ease of use. The bracket positioning device 110 may be constructed from various materials, such as plastic, wood, metal, ceramic, or the like. In one embodiment, the bracket positioning device 110 may be made from injection molded plastic. The indexing pin 420 may also be constructed from various materials, such as plastic, wood, metal, ceramic, or the like. Preferably the material is compatible with cleaning and sterilizing agents and processes.

The bracket positioning device 110 may further include a cable 430 which couples the bracket positioning sensor to computing system 130 for sending positional tracking signals from the bracket positioning sensor as described herein. In some cases, the bracket positioning device 110 can include visual feedback like a green LED lighting up, haptic feedback, for example a vibration motor controlled by a tactile feedback signal (which may be provided using a cable 430). In some cases, the handle 410 can include a user-activated button providing a signal that indicates a desired bracket placement, which the computing system 130 may store in storage unit 140.

FIGS. 5A and 5B illustrate a perspective view and a bottom view, respectively, of an orthodontic bracket 500. Specifically, orthodontic bracket 500 may include a bonding base 520 for attachment to a tooth surface. The orthodontic bracket 500 may further include an archwire slot formed by four tie wings or projections 510 on either side of the bracket 500, forming a rectangular slot or groove. The slot is designed to hold a wire connecting each of the affixed brackets one to another for the upper set of teeth, forming a dental arch and a similar arch for the lower set of teeth. The tie wings typically hold the archwire by means of a wire or elastic ligature. The four tie wings help facilitate the orientation of the tooth. The slot in each of the tie wings allows for movement of teeth vertically and also allows for tipping of the root or crown. The slot is rectangular so as to be able to accommodate a rectangular cross-section wire which allows an individual tooth to be moved in a third dimension that torques or tips the root of the tooth. The orthodontic bracket 500 can be made from man-made materials, such as ceramic and plastic, or many types of metals including, but not limited to, gold, titanium, and stainless steel.

FIG. 6 illustrates a bracket placement tip 600 having an orthodontic bracket 500 removably coupled thereto; and FIG. 7 shows a bracket positioning device 110 with a bracket placement tip 600 coupled thereto. As shown in FIG. 6, an orthodontic bracket 500 may be precoupled into a bracket placement tip 600 at the end 610, where the two tie wings 510 of the bracket 500 engage within the tip with breakable cement, such that the bonding base 520 is exposed and may be applied to a tooth. During bracket placement or planning, dental cement may additionally be applied to the bonding base 520 to couple the bracket 500 to the actual tooth or physical model. In the alternative, the bracket 500 may be previously coupled to the bracket placement tip 600 (e.g., pre-attached) so that when the bracket 500 is applied to a tooth, it is possible to snap off the bracket from the breakable bracket placement tip 600. The breakable cement may include any adhesive that is weak enough for the placement tip 600 to break off of the bracket 500 without breaking the tooth. The breakable cement may be selected from a group of various adhesives weaker than light cured adhesive including but not limited to, such as a thermoplastic adhesive. Once the bracket 500 is snapped off the breakable bracket placement tip 600, the bracket placement tip 600 may be discarded. Instead of breakable cement, a grab and release mechanism can be included in the tip of the bracket placement tool.

The bracket placement tip 600 may be a solid post, or it may include a bracket detecting circuit that detects the specific type of bracket coupled thereto. The bracket placement tip 600 can be any size or shape sufficient to enable ease of use for application of brackets to actual teeth or a model thereof. Such bracket placement tip 600 can be circular or rectangular cross-section. The particular example shown in FIG. 6 possesses a circular cross-section, the bracket placement tip 600 may be solid, hollow, porous, or have other properties as desired. In some cases, a visible (blue) light source may be included within or coupled to the end 610 of the bracket placement tip 600 to cure the dental cement applied between the bracket 500 and the patient's teeth. The bracket placement tip 600 may be constructed from various materials, such as plastic, wood, metal, ceramic, or a material compatible with cleaning and sterilizing agents and processes for reusable tips. Tips may be disposable or reusable.

The bracket placement tip 600 can include a notch or groove 630 for coupling to the bracket positioning device 110 as illustrated in FIGS. 6, 7. During the planning stage, a bracket planning pointer tip 730 may be coupled to the bracket positioning device 110, such that the operator may simulate the application of a bracket to the patient's teeth. Of course, in some cases, actual brackets may be used during the planning stage. The bracket placement tips 600, 730, and 740 can be of various sizes and made of various materials.

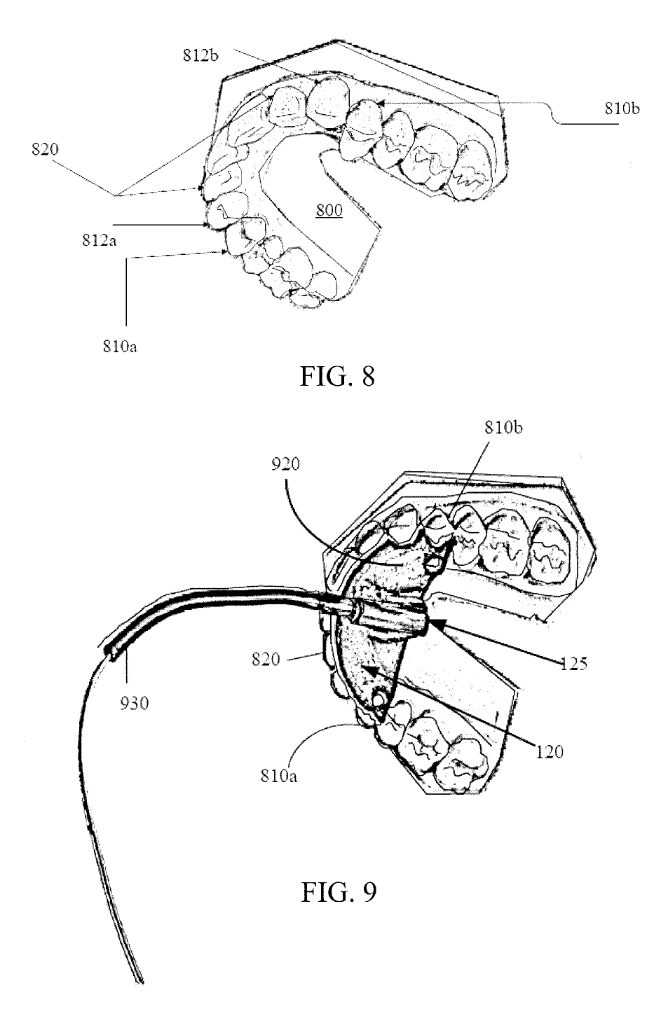

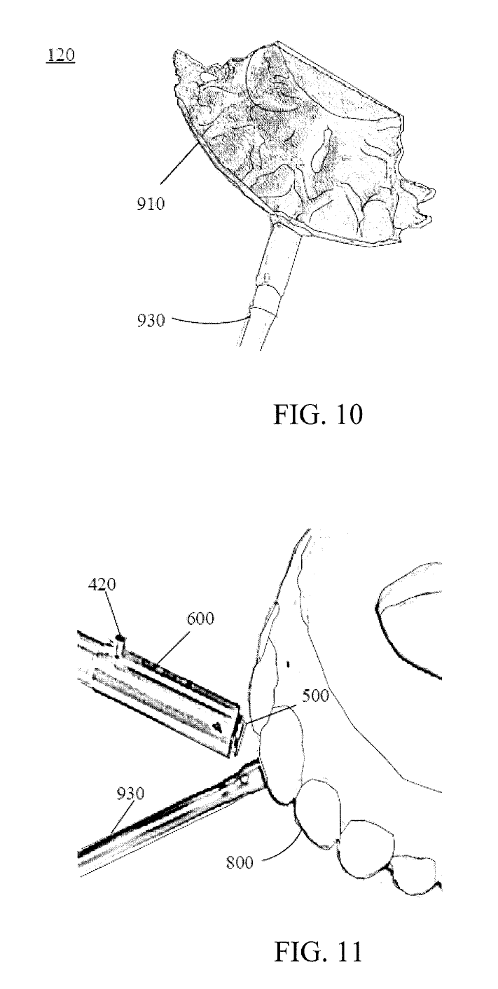

FIG. 8 shows an upper dental arch 800 of the patient's actual teeth 150 or a physical model of the patient's teeth 151; and FIG. 9 shows an indexing tool 120 fit to the dental arch 800 of FIG. 8; while FIG. 10 shows an example conformal side of the indexing tool 120. The upper dental arch 800 of the patient's teeth 150 represents an actual patient's dental upper arch as well as the physical model 151 of the patient's dental arch, in as much as an indexing tool 120 may interchangeably fit (e.g., at the conformal side 910 illustrated in FIG. 10) to at least a portion of the patient's teeth and/or alveolar process 150. The indexing tool 120 can be any size or shape sufficient to enable ease of use for detection of the position of actual teeth or a model thereof. Such indexing tool 120 can be molded to fit the patient's dental arch, abutting all or any portion of the set of teeth and be cleanable. The indexing tool 120 may be solid, hollow, porous, or have other properties as desired. In the illustrative example as shown in FIGS. 8-10, index tool 120 conformingly abuts a portion of a palate, the incisors 820, two canine teeth 812a, 812b, and two premolar teeth 810a, 810b of an upper dental arch 800. The indexing tool 120 includes a body portion 920 comprising one or more sensors 125 (as shown in FIG. 1) for sensing the spatial position of the subject's teeth or the physical model thereof depending on whether the indexing tool is fitted to the patient or the physical model of the patient's teeth. The sensors 125 may be molded within the body portion 920 or sit within a hollow portion of the body portion 920. The sensors 125 may couple to the extension portion 930. Output from the sensors may be communicated to a computing system using, for example, an output cable extending from an extension portion 930 of the indexing tool 120 to the computing system 130. The indexing tool 120 may be constructed from various materials, such as plastic, metal, ceramic, or the like. In one embodiment, the indexing tool 120 may be made from injection molded plastic.

The sensor(s) 125 can be embedded within, or disposed exteriorly of, the body portion 920. The positioning of the sensor(s) may be such that the position of one or more teeth may be detected and known. The sensor may also be positioned such that the position of one or more brackets on the surface of one or more of the subject's teeth can be readily detected and known. Although the indexing tool 120 is illustrated in FIG. 9 as conforming to the inside (lingual) surface of a subject's teeth/physical model 150, 151 (i.e., back side of the teeth and palate), it can also be designed/molded to interact with the front (buccal) surface of the teeth/physical model 150, 151. Interaction of the indexing tool 120 with the front surface is useful when placing brackets on the back (lingual) side of teeth.

The exterior surface 910 of the body portion of the indexing tool 120 may be designed using a customized mold of the person's mouth and teeth. The extension portion 930 may in some cases be used for placing the indexing tool 120 in the person's mouth.

FIG. 11 illustrates placement of a bracket 500 according to an example implementation. In particular, FIG. 11 shows an indexing pin 420 of bracket positioning device 110 having a bracket applicator tip 600 that may be provided to interact with the patient's actual or physical modeled upper dental arch 800 having the indexing tool 120 fitted thereto. Tracking of the bracket 500 as it is placed into position (in either the planning stage or the placement stage) allows mirroring of the operator's movement of the bracket 500 in a virtual model representation thereof, and a resulting interaction of the virtual bracket with the virtual model of the person's teeth. Thus, an operator can visualize the interaction and positioning of the bracket against the person's teeth, or physical model thereof, with the virtual model of the person's teeth while also interacting with a physical object.

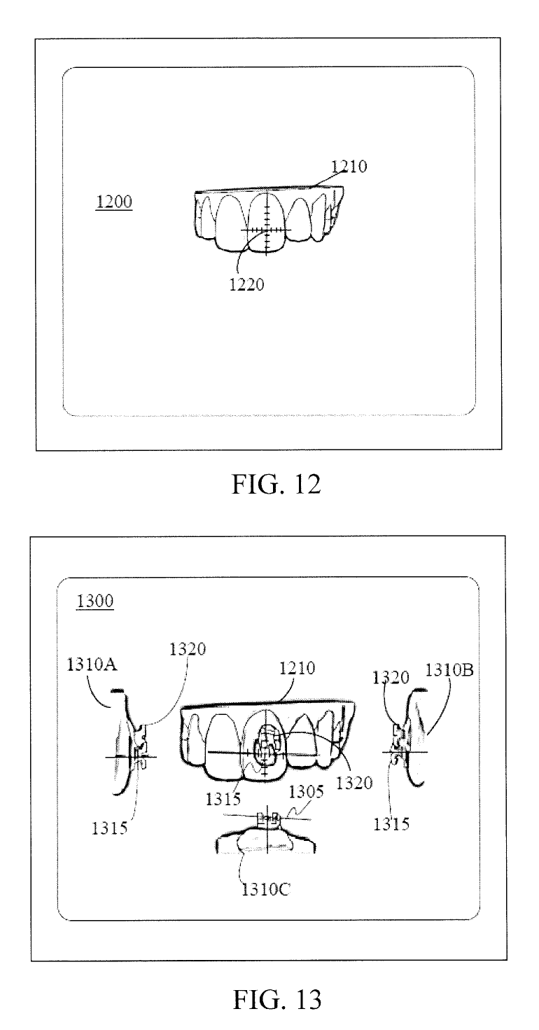

FIG. 12 shows a graphical user interface 1200 with a representation of a virtual model 1210 of a person's upper arch on which a representation of a bracket may be displayed during a planning stage. FIG. 13 shows a graphical user interface 1300 with a representation of a virtual model 1210 of a person's upper arch on which a representation of a planned bracket position 1315 and a representation of a detected bracket position 1320 is displayed during the placement stage. The graphical user interfaces shown in FIGS. 12 and 13 may be displayed on a computing device such as described with respect to FIG. 14. Referring to FIG. 12, a planning screen 1200 may display a graphical representation of a virtual model 1210 having a two dimensional axis 1220 for illustrating the positioning of the planned bracket positions. In FIG. 13, a planned bracket position 1315 and optional two dimensional axis 1305 are shown on a virtual model 1210 of the person's teeth. Additional views and angles may be provided such as a left, front view 1310A; right, front view 1310B; and bottom plan view 1310C. Similarly, the planned bracket position 1315 and optional two dimensional axis 1305 can be provided for each view.

During the placement stage, a real-time bracket position 1320 of a bracket that is being positioned can be displayed on the virtual model 1210 (and views 1310A-1310C). FIG. 13 illustrates the planned virtual bracket position 1315 and a real-time virtual position 1320 of a bracket (such as bracket 500 shown in FIG. 11). In particular, FIG. 13 illustrates a bracket 500 that is not in a position to be bonded to the tooth because it is not yet aligned with the planned position 1315. In some cases, notification to the operator that the bracket is in the appropriate position can include a visual alert on the screen 1300 to notify the operator that a match has occurred, including but not limited to color change indicator, flashing illumination indicators, and brightness and/or contrast adjustments to the screen 1300. Computing system 130 may further generate an audio feedback through a speaker or a tactile feedback signal to the bracket positioning device (e.g., device 110) to indicate the same. A miniature video camera mounted on the bracket positioning device can facilitate viewing of the bracket by the user especially when working with non-frontal teeth such as molars. An articulated tip for the bracket positioning device can facilitate guided placement of brackets on non-frontal teeth without easy access such as molars.

FIG. 14 illustrates a block diagram of a computing system 1400 for a computer device that may be used to implement certain techniques described herein. Specifically, system 1400 may represent a computing device such as, but not limited to, a personal computer, a tablet computer, a reader, a mobile device, a personal digital assistant, a wearable computer, a smartphone, a tablet, a laptop computer (notebook or netbook), a gaming device or console, a desktop computer, or a smart television. Accordingly, more or fewer elements described with respect to system 1400 may be incorporated to implement a particular computing device.

Computing system 1400 may include an Input/Output (I/O) controller 1402, a system memory 1410, memory controller 1430, processing system 1440, user interface system 1460 and network/communications interface 1450, each of which may be interconnected using a communication infrastructure 1470. Communication infrastructure 1470 generally represents any type or form of infrastructure capable of facilitating communication between one or more components of a computing device. Examples of communication infrastructure 1470 include, without limitation, a communication bus (such as an International Standard Architecture (ISA), Parallel Communication Interface (PCI), PCI-Express (PCIe), or similar bus) or any network.

System 1400 includes a processing system 1440 of one or more processors to transform or manipulate data according to the instructions of software 1420 stored on a system memory 1410. Examples of processors of the processing system 1440 include general purpose central processing units, application specific processors, and logic devices, as well as any other type of processing device, combinations, or variations thereof. The processing system 1440 may be, or is included in, a system-on-chip (SoC) along with one or more other components such as network connectivity components, sensors, and video display components.

The software 1420 can include an operating system and application programs such as bracket application software 1422 (e.g., for carrying out the processes described with respect to FIGS. 2A, 2B, and 3) and/or web browsing application 1426 (which may be used to access a web-based bracket application software for carrying out the processes described with respect to FIGS. 2A, 2B, and 3). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 14, can be thought of as additional, nested groupings within the operating system space, each containing an OS, application programs, and APIs.

System memory 1410 may comprise any computer readable storage media readable by the processing system 1440 and capable of storing software 1420 including the bracket application 1422 and/or web browsing application 1426.

System memory 1410 may include volatile and nonvolatile, removable and non-removable media implemented in any method or technology for storage of information, such as computer readable instructions, data structures, program modules, or other data. Examples of storage media of system memory 1410 include random access memory, read only memory, magnetic disks, optical disks, CDs, DVDs, flash memory, virtual memory and non-virtual memory, magnetic storage devices or any other suitable storage media. In no case is the storage medium a propagated signal or carrier wave.

System memory 1410 may be implemented as a single storage device but may also be implemented across multiple storage devices or sub-systems co-located or distributed relative to each other. System memory 1410 may include additional elements, such as a controller, capable of communicating with processing system 1440.

In addition to storage media, in some implementations, system memory 1410 may also include communication media over which software may be communicated internally or externally.

Software 1420 may be implemented in program instructions and among other functions may, when executed by system 1400 in general or processing system 1440 in particular, direct system 1400 or the one or more processors of processing system 1440 to operate as described herein.

In general, software may, when loaded into processing system 1440 and executed, transform computing system 1400 overall from a general-purpose computing system into a special-purpose computing system customized to retrieve and process the information for an orthodontic bracket application as described herein for each implementation. Indeed, encoding software on system memory 1410 may transform the physical structure of system memory 1410. The specific transformation of the physical structure may depend on various factors in different implementations of this description. Examples of such factors may include, but are not limited to the technology used to implement the storage media of system memory 1410 and whether the computer-storage media are characterized as primary or secondary storage.

The system can further include user interface system 1460, which may include input/output (I/O) devices and components that enable communication between a user and the system 1400. User interface system 1460 can include input devices such as a—pointing device. 1462, track pad (not shown), keyboard 1464, a touch device 1470 for receiving a touch gesture from a user, a motion input device 1472 for detecting non-touch gestures and other motions by a user, a microphone for detecting speech, and other types of input devices and their associated processing elements capable of receiving user input.

The user interface system 1460 may also include output devices such as display screens 1468, speakers 1474, haptic devices for tactile feedback, and other types of output devices. In certain cases, the input and output devices may be combined in a single device, such as a touchscreen display, which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may use any other touchscreen technology. In some embodiments, the touchscreen is incorporated on top of a display as a transparent layer to enable a user to use one or more touches to interact with objects or other information presented on the display.

Visual output may be depicted on the display 1468 in myriad ways, presenting graphical user interface elements, text, images, video, notifications, virtual buttons, virtual keyboards, or any other type of information capable of being depicted in visual form.

The user interface system 1460 may also include user interface software and associated software (e.g., for graphics chips and input devices) executed by the OS in support of the various user input and output devices. The associated software assists the OS in communicating user interface hardware events to application programs using defined mechanisms. The user interface system 1460 including user interface software may support a graphical user interface, a natural user interface, or any other type of user interface. For example, the interfaces for users to access the orthodontic bracket application software and the sensing and control devices described herein may be presented through user interface system 1460.

Communications interface 1450 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

In some cases, aspects of computing system 1400 may also represent a computing system on which software may be staged and from where software may be distributed, transported, downloaded, or otherwise provided to yet another computing system for deployment and execution, or yet additional distribution.

Certain techniques set forth herein with respect to sensing and tracking brackets on teeth may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that the examples and embodiments described herein are for illustrative purposes only and that various modifications or changes in light thereof will be suggested to persons skilled in the art and are to be included within the spirit and purview of this application.

What is claimed is:

1. A method of guided orthodontic bracket placement, comprising:
detecting a position of at least one actual orthodontic bracket in proximity to at least one tooth of a patient;
comparing the detected position to a planned placement position for a particular tooth; and
providing a notification when the actual bracket position meets a specified criteria with respect to the planned placement position.

2. The method of claim 1, wherein the method further comprises detecting a position of at least one actual orthodontic bracket in proximity to at least one tooth of a patient.

3. The method of claim 1, wherein the notice is an audio alert.

4. The method of claim 1, wherein the notice is a visual display alert.

5. The method of claim 1, wherein the notice is a tactile alert signal sent to an orthodontic positioning device used to position the actual bracket in proximity to the at least one tooth.

6. The method of claim 1, wherein the detecting of the position of the at least one actual orthodontic bracket comprises receiving signals from at least a bracket placement tool fitted within a patient's mouth.

7. The method of claim 1, wherein the specified criteria comprises a matching condition where the actual bracket position matches the planned placement position.

8. The method of claim 1, further comprising:
detecting a position of a representative bracket with respect to a physical model of the at least one tooth of the patient;
receiving input indicating a current detected position of the representative bracket with respect to the physical model of the at least one tooth of the patient is to be stored; and
storing the current detected position as the planned placement position.

9. A computer-readable storage medium, having instructions stored thereon that, when executed by a processing system, direct the processing system to:
access a virtual model of a patient's teeth;
track a representational bracket position and rotation with respect to a physical model of the patient's teeth;
display a virtual representation of the representational bracket and at least one of the patient's teeth from the virtual model of the patient's teeth according to the tracked representational bracket position;
store a final bracket positon as a planned bracket position in response to receiving an indication of a current bracket position being the final bracket position;
track a position of at least one actual orthodontic bracket with respect to at least one tooth of the patient;
display a virtual representation of the actual bracket according to the position of the at least one actual orthodontic bracket on the virtual model;
compare the planned bracket position to the position of the at least one actual orthodontic bracket; and
provide a notification when the position of the at least one actual orthodontic bracket meets a specified criteria with respect to the planned placement position.

10. The medium of claim 9, wherein the medium further comprises instructions to track a position with respect to a physical model of the patient's teeth.

11. The medium of claim 9, wherein the planned bracket position is displayed with the virtual representation of the actual bracket.

12. A system for guided orthodontic bracket placement, comprising:
an indexing tool comprising a body portion designed to conform to a patient's teeth; and an indexing tool tracking sensor disposed within the body portion, wherein the indexing tool sensor provides spatial position and orientation data of the patient's teeth;
a bracket positioning device comprising an attached tracking sensor, wherein the tracking sensor provides spatial position data for an orthodontic bracket; and
one or more computer readable storage media having stored thereon instructions that, when executed by a processing system, direct the processing system to:
in response to receiving data from the indexing tool sensor and the bracket position sensor, detect a position of at least one actual orthodontic bracket in proximity to at least one tooth of a patient;
compare the detected position to a planned placement position for a particular tooth; and
provide a notification when the actual bracket position meets a specified criteria with respect to the planned placement position.

13. The system of claim 12, further comprising:
an audio output device, wherein the instructions to provide the notification direct the processing system to provide an audio alert using the audio output device.

14. The system of claim 12, further comprising:
a display, wherein the instructions to provide the notification direct the processing system to provide a visual display alert using the display.

15. The system of claim 12, wherein the instructions to provide the notification direct the processing system to provide a tactile alert signal to a haptic component of the bracket positioning device.

16. The system of claim 12, wherein the specified criteria comprises a matching condition where the actual bracket position matches the planned placement position.

17. The system of claim 12, further comprising instructions stored on the one or more computer readable storage media that, when executed by the processing system, direct the processing system to:
in response to receiving data from the indexing tool sensor and the bracket position sensor, detect a position of a representative bracket with respect to a physical model of the at least one tooth of the patient; and
in response to receiving an input indicating a current detected position of the representative bracket with respect to the physical model of the at least one tooth of the patient is to be stored, store the current detected position as the planned placement position.

18. A bracket position device comprising a handle and a socket with an indexing pin adapted from coupling to either a bracket planning pointer tip or a bracket placement tip, wherein said device further comprises a tracking sensor.

19. The bracket positioning device, according to claim 18, which further comprises a video camera.

20. The bracket positioning device, according to claim 18, which comprises an articulated tip.

21. An indexing tool comprising a body portion that is adapted to conform to the teeth of a specific patient, wherein said indexing tool further comprises a tracking sensor.

22. The system, according to claim 12, which further comprises a system for preloading brackets in a given placement sequence in a bracket magazine to speed up placement.
